(19) United States
(12) Patent Application Publication
(10) Pub. No.: US 2021/0132622 A1
(43) Pub. Date: May 6, 2021

(54) METHOD AND DEVICE FOR OPERATING AN AUTOMATED VEHICLE

(71) Applicant: Robert Bosch GmbH, Stuttgart (DE)

(72) Inventors: Carsten Hasberg, Ilsfeld-Auenstein (DE); Christoph Schroeder, Sunnyvale, CA (US); Danny Hiendriana, Ludwigsburg (DE); Oliver Pink, Ditzingen (DE); Philipp Rasp, Wannweil (DE)

(21) Appl. No.: 16/499,973

(22) PCT Filed: Mar. 21, 2018
(86) PCT No.: PCT/EP2018/057138

§ 371 Date: Oct. 1, 2019

(30) Foreign Application Priority Data
Apr. 6, 2017 (DE) 10 2017 205 880.3

(51) Int. Cl. G05D 1/02; G01C 21/28; G01C 21/36

(52) U.S. Cl. CPC G05D 1/0248; G05D 1/0278; G01C 21/3602; G01C 21/28; G05D 1/0274

(57) ABSTRACT

A method and a device are described for operating an automated vehicle including determining a coarse position of the automated vehicle, determining first environment data values as a function of the coarse position, the first environment data values representing a target environment of the automated vehicle, recording second environment data values using an environment sensor system of the automated vehicle, the second environment data values representing an actual environment of the automated vehicle, determining a highly accurate position of the automated vehicle, as a function of a comparison between the actual environment and the target environment, and operating the automated vehicle, as a function of the highly accurate position.

### BACKGROUND INFORMATION

The present invention relates to a method and to a device for operating an automated vehicle, comprising determining a coarse position of the automated vehicle, determining first environment data values as a function of the coarse position, recording second environment data values using an environment sensor system of the automated vehicle, determining a highly accurate position of the automated vehicle, and operating the automated vehicle.

### SUMMARY

An example method according to the present invention for operating an automated vehicle comprises determining a coarse position of the automated vehicle and determining first environment data values as a function of the coarse position, the first environment data values representing a target environment of the automated vehicle. The method furthermore comprises recording second environment data values using an environment sensor system of the automated vehicle, the second environment data values representing an actual environment of the automated vehicle, determining a highly accurate position of the automated vehicle, as a function of a comparison between the actual environment and the target environment, and operating the automated vehicle, as a function of the highly accurate position.

An automated vehicle is to be understood as a partially or highly or fully automated vehicle.

A coarse position is to be understood as a position, for example in GPS coordinates, which is inaccurate at least to such a degree that an automated vehicle cannot be operated as a function of this coarse position. A coarse position is for example a position as determined and/or displayed by a navigation system. A coarse position of a vehicle allows for example for a localization with respect to a section of a road, whereas the determination of a driving lane, for example on a multi-lane roadway, is nearly impossible. A coarse position is—typically—determined with an inaccuracy of several meters, the inaccuracy depending, among other factors, on the environment of the vehicle.

A highly accurate position is to be understood as a position that is at least accurate to such a degree that it is possible to operate an automated vehicle as a function of this highly accurate position. A highly accurate position is for example accurate to such a degree that a localization of a vehicle is possible with respect to a driving lane and/or relative to the driving lane boundaries. A highly accurate position is—typically—determined with an inaccuracy of at most 10 cm.

A target environment of the automated vehicle is to be understood as at least one environmental feature that is supposed to be situated, according to the coarse position of the automated vehicle, within range of at least one sensor of the environment sensor system of the automated vehicle. For example, the coarse position is determined by a navigation system in such a way that the automated vehicle is localized in proximity of a gas station, the gas station being comprised by a map of the navigation system. The gas station thereby represents a target environment of the automated vehicle as a feature of the environment, which may be recorded by at least one sensor of the environment sensor system of the automated vehicle.

An actual environment of the automated vehicle is to be understood for example as at least one environmental feature that is recorded by at least one sensor of the environment sensor system of the automated vehicle.

An environment sensor system is to be understood as at least one sensor, which is designed to record an actual surroundings of the automated vehicle in the form of second environment data values.

An operation of an automated vehicle is to be understood for example as an automated control of the lateral and/or longitudinal control of the automated vehicle, as a function of the highly accurate position. For example, a steering action of the automated vehicle is performed when the automated vehicle approaches a curve and/or a driving lane boundary and/or a—negative or positive—acceleration is performed when the automated vehicle approaches a hazard area or drives off again following a standstill.

Determining a highly accurate position may be very processing-intensive and/or time-consuming and/or require great quantities of data. The method according to the present invention has the advantage that in a first step (only) a coarse position is determined, which occurs quickly on the one hand and without great processing-expenditure on the other hand, for example with the aid of a navigation system. Subsequently, the highly accurate position is determined, the highly accurate position, due to the previously determined coarse position, being determined by a comparison of the target environment and the actual environment using relatively small data quantities and thus in such a short time that a safe operation of an automated vehicle becomes possible.

Preferably, the first environment data values are determined in that the first environment data values are read out from a map.

A map is to be understood for example as a digital map of a navigation system, the map being stored in the form of map data values in a memory of the navigation system or on a storage medium of the automated vehicle. In one specific embodiment, the map is combined for example in the form of map data values with a GPS sensor and/or an acceleration sensor and/or another localization sensor in such a way that a coarse position of the automated vehicle may be determined.

This may provide the advantage that the method may be executed very quickly since the target environment is already stored as a map in the automated vehicle. This increases safety in the operation of the automated vehicle.

Preferably, the first environment data values are determined as a function of the environment sensor system of the automated vehicle.

This may provide the advantage that the method may be executed by any automated vehicle, which allows the method to be applied in diverse ways and thus to be manufactured in a cost-effective manner.

Particularly preferably, the first environment data values are determined as a function of the environment sensor system of the automated vehicle in such a way that the target environment corresponds to the expected actual environment of the automated vehicle.

This may provide the advantage that the comparison may be performed particularly quickly and effectively, which increases the accuracy of the highly accurate position and thus increases the safety in the operation of the automated vehicle.

In a particularly preferred specific embodiment, the highly accurate position is determined in that the target environment comprises at least one environmental feature, at least one first parameter being assigned to the at least one environmental feature, the actual environment comprising at least one comparable environmental feature, at least one second parameter being assigned to the at least one comparable environmental feature, and the highly accurate position being determined as a function of the comparison between the at least one first parameter and the at least one second parameter.

The at least one environmental feature and/or the at least one comparable environmental feature is/are to be understood for example as a structure (building, bridge, tunnel, etc.) and/or an infrastructure feature (guardrail, road marking, traffic sign, etc.) and or a landscape feature (plant, body of water, mountain, field, etc.). Both types of environmental features, the at least one environmental feature and the at least one comparable environmental feature, are comparable since both represent the same environmental feature, which, however, is determined and/or detected using different means.

The at least one first parameter and/or the at least one second parameter are physical variables for example (length, angle, etc.), which may be recorded by an environment sensor system and/or read out from a map.

This may provide the advantage that the comparison may be performed particularly quickly and effectively, which increases the accuracy of the highly accurate position and thus increases the safety in the operation of the automated vehicle.

Particularly preferably, the highly accurate position is determined as a function of the comparison between the at least one first parameter and the at least one second parameter in that the highly accurate position is determined by way of a function of the comparison, in particular of a difference between the at least one first parameter and the at least one second parameter.

Both parameter types, the at least one first parameter and the at least one second parameter, are comparable since both represent the same parameter, which, however, is determined and/or detected using different means.

This may provide the advantage that the highly accurate position may be determined quickly, reliably and with great accuracy starting from small quantities of data, which represent the at least one first and the at least one second parameter, using mathematical methods in the form of functions.

Preferably, the automated vehicle is operated in such a way that the automated vehicle is operated in automated fashion along a trajectory that is determined as a function of the highly accurate position.

This advantageously allows for a safe and effective operation of the automated vehicle.

An example device according to the present invention for operating an automated vehicle comprises first means for determining a coarse position of the automated vehicle and second means for determining first environment data values as a function of the coarse position, the first environment data values representing a target environment of the automated vehicle. The device furthermore comprises third means for recording second environment data values using an environment sensor system of the automated vehicle, the second environment data values representing an actual environment of the automated vehicle, fourth means for determining a highly accurate position of the automated vehicle, as a function of a comparison between the actual environment and the target environment and fifth means for operating the automated vehicle as a function of the highly accurate position.

Preferably, the first means and/or the second means and/or the third means and/or the fourth means and/or the fifth means are designed to implement the example method as described herein.

Advantageous further developments of the present invention are described herein.

### BRIEF DESCRIPTION OF THE DRAWINGS

Exemplary embodiments of the present invention are shown in the figures and explained in greater detail below.

FIG. 1 shows an exemplary embodiment of the device according to the present invention purely by way of example.

FIG. 2 shows an exemplary embodiment of the method according to the present invention in purely exemplary fashion.

FIG. 3 shows an exemplary embodiment of the method according to the present invention in the form of a flow chart in purely exemplary fashion.

### DETAILED DESCRIPTION OF EXAMPLE EMBODIMENTS

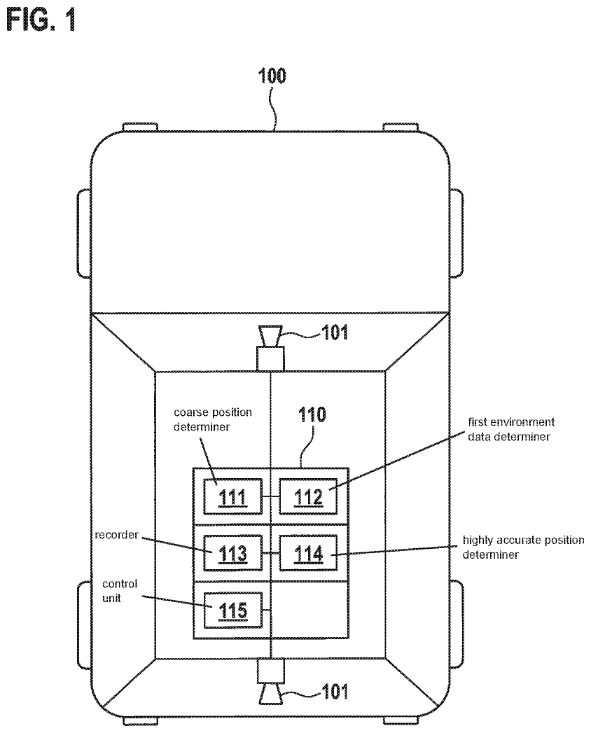

FIG. 1 shows a vehicle 100, which comprises the device 110 of the present invention for operating 360 an automated vehicle 100.

Device 110 comprises first means 111 for determining 320 a coarse position 210 of automated vehicle 100, second means 112 for determining 330 first environment data values as a function of the coarse position 210, the first environment data values representing a target environment 220 of automated vehicle 100, and third means 113 for recording 340 second environment data values using an environment sensor system 101 of automated vehicle 100, the second environment data values representing an actual environment 230 of automated vehicle 100. Device 110 furthermore comprises fourth means 114 for determining 350 a highly accurate position 240 of automated vehicle 100, as a function of a comparison between the actual environment 230 and the target environment 220, and fifth means 115 for operating 360 automated vehicle 100 as a function of the highly accurate position 240.

The first means 111 for determining 320 a coarse position 210 are developed for example as a navigation system that describes the coarse position 210 of automated vehicle 100 using GPS data. In another specific embodiment, the coarse position 210 is determined using for example an acceleration sensor and/or a VMPS sensor. In another specific embodiment, first means 111 are developed as a transmitter and/or receiver unit, which determines the coarse position 210 in that the latter is transmitted by a mobile position determination unit, for example a smart phone, which is located within automated vehicle 100, and is received by first means 111. First means 111 are furthermore developed to transmit the coarse position 210 in the form of data values to second means 112.

Within the scope of method 300 of the present invention, a position (coarse position 210 and/or highly accurate position 240) is to be understood as a position of automated vehicle 100 and/or the orientation of automated vehicle 100 relative to this position. An orientation is to be understood for example as the direction of movement of automated vehicle 100, which is represented in form of a vector, starting from the position, and/or in form of a cardinal direction.

Second means 112 for determining 330 first environment data values as a function of the coarse position 210 are developed for example as a processing unit (processor, working memory, hard disk), which comprises corresponding software in order to determine the first environment data values. For this purpose, second means 112 comprise for example a (digital) map, which comprises the first environment data values.

In one specific embodiment, first means 111 and second means 112 are identical and are developed as a navigation system.

The determination 330 of the first environment data values occurs for example in such a way that the map comprises environmental features together with a respective position and that starting from the coarse position 210 the first environment data values comprise precisely the at least one environmental feature 221-224, which is located for example—according to specified criteria—near the coarse position 210 and/or in a direction of movement of automated vehicle 100. The specified criteria are to be understood for example in the sense that all environmental features are selected that are located within a specific distance from coarse position 210.

In one specific embodiment, the map of second means 112 comprises the at least one environmental feature 221-224 together with the position and physical variables that describe the at least one environmental feature 221-224 (width of a building, width of a roadway, height of a guardrail, distances of a building from the roadway, diameter of a body of water, angle of an edge of a building relative to the roadway, height of a traffic sign, distance of a traffic sign from the roadway, etc.)

Second means 112 are furthermore designed to transmit the target environment 220 in the form of first environment data values to fourth means 114.

Third means 113 for recording 340 second environment data values using an environment sensor system 101 of automated vehicle 100, the second environment data values representing an actual environment 230 of automated vehicle 100, are designed for example as an evaluation unit (processor, working memory, hard disk), which is connected to environment sensor system 201.

Environment sensor system 201 of automated vehicle 100 comprises at least one sensor, the at least one sensor being for example a video sensor and/or a radar sensor and/or a Lidar sensor and/or an ultrasonic sensor and/or another sensor for recording an actual environment 230 of automated vehicle 100.

By way of suitable software, third means 113 are for example designed to record and/or evaluate the second environment data values, the evaluation occurring as a function of environment sensor system 201. If the at least one sensor is developed as a video sensor for example, then the second environment data values are recorded 340 in the form of an image, the evaluation comprising an object classification to determine the at least one comparable environmental feature in the actual environment 230. The third means 113 are furthermore designed to record the second environment data values in that the actual environment 230 comprises at least one comparable environmental feature, at least one second parameter being assigned to the at least one comparable environmental feature. Third means 113 are furthermore designed to transmit the actual environment 230 in the form of second environment data values to fourth means 114.

Fourth means 114 for determining 350 a highly accurate position 240 of automated vehicle 100, as a function of a comparison between the actual environment 230 and the target environment 220, are developed for example as a processing unit (processor, working memory, hard disk). Fourth means 114 are furthermore developed to receive the target environment 220 in the form of first environment data values and the actual environment 230 in the form of second environment data values.

The highly accurate position 240 is determined 350 for example in that the target environment 220 comprises at least one environmental feature 221-224, at least one first parameter P₂₁, P₂₂, P₂₃, P₂₄ being assigned to the at least one environmental feature 221-224, the actual environment 230 comprising at least one comparable environmental feature, at least one second parameter being assigned to the at least one comparable environmental feature, and the highly accurate position 240 being determined as a function of the comparison between the at least one first parameter P₂₁, P₂₂, P₂₃, P₂₄ and the at least one second parameter.

In another specific embodiment, the highly accurate position 240 is determined as a function of the comparison between the at least one first parameter P₂₁, P₂₂, P₂₃, P₂₄ and the at least one second parameter in that the highly accurate position 240 is determined by way of a function of the comparison, in particular of a difference between the at least one first parameter P₂₁, P₂₂, P₂₃, P₂₄ and the at least one second parameter.

In one specific embodiment, the at least one first parameter P₂₁, P₂₂, P₂₃, P₂₄ represents a first vector V₁ of the at least one environmental feature 221-224, which describes a length and/or the orientation of this length (for example in GPS coordinates). With the aid of the environment sensor system 101 (video, radar, Lidar, etc.), the at least one comparable environmental feature is recorded in the form of an image, the image representing the at least one comparable environmental feature in such a way that at least one second parameter is assigned to the at least one comparable environmental feature. For example, starting from the image, the processing unit of fourth means 114, which comprises suitable software, determines a second vector V₂, which is comparable to first vector V₁. On the basis of the comparison of the two vectors V₁ and V₂, for example by way of a first function (the difference of the vectors) f₁(V₁,V₂)=V₁−V₂ and/or a second function (the difference of the absolute value of the vectors) f₂(V₁,V₂)=|V₁−V₂| or alternatively f₂ (V₁,V₂)=|V₁|−|V₂| and/or by way of at least one further function f₃=f₃(V₁,V₂), the highly accurate position 240 is determined as a function of at least one of the comparison options (functions) described above starting from the respective function values, for example by way of a comparison with reference values and/or reference vectors stored in fourth means 114.

The fifth means 115 for operating 360 the automated vehicle 100, as a function of the highly accurate position 240, are developed for example as at least one control unit for controlling a lateral and/or longitudinal control of automated vehicle 100.

In another specific embodiment, the fifth means 115 are developed for example as at least one control unit in such a way that the operation 360 of automated vehicle 100 occurs in such a way that automated vehicle (100) is operated in automated fashion along a trajectory 250, which is determined as a function of the highly accurate position (240).

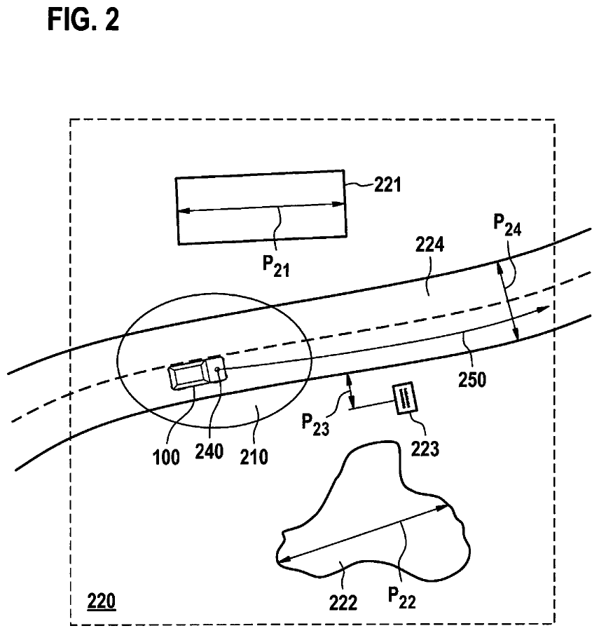

FIG. 2 shows an exemplary embodiment of method 300 of the present invention for operating 360 an automated vehicle 100, in this case, the operation 360 of automated vehicle 100 occurring, by way of example, in such a way that automated vehicle 100 is operated in automated fashion along a trajectory 250, which is determined as a function of the highly accurate position 240.

Automated vehicle 100 is located on a traffic route 224. First environment data values representing a target environment 220 of the vehicle are determined as a function of the coarse position 210 of automated vehicle 100, the target environment 220 comprising environmental features 221-224, which in this case are embodied, by way of example, as a building 221, a body of water 222, a traffic sign 223 and a traffic route 224. At least one first parameter P₂₁, P₂₂, P₂₃, P₂₄ is assigned to each environmental feature 221-224. Parameter P₂₁ represents a width of the building. Parameter P₂₂ represents an extension of the body of water 222, parameter P₂₃ represents a distance of the traffic sign 223 from the traffic route 224 and parameter P₂₄ represents a width of the traffic route 224.

As a function of a comparison between the actual environment 230 and the target environment 220, the highly accurate position 240 of automated vehicle 100 is determined for example by way of a function of the comparison between the at least one first parameter P₂₁, P₂₂, P₂₃, P₂₄ and at least one second parameter, which is assigned to at least one comparable environmental feature.

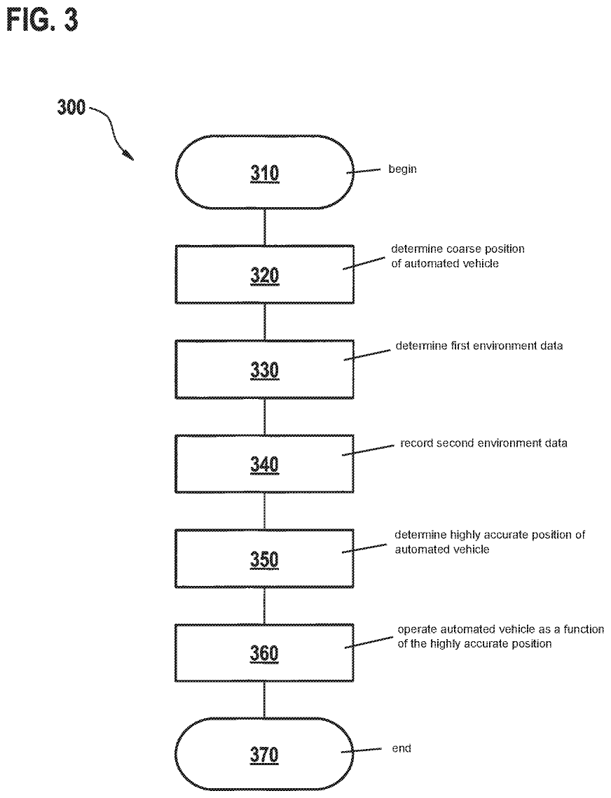

FIG. 3 shows an exemplary embodiment of the method 300 according to the present invention in the form of a flow chart.

Method 300 begins with step 310.

In step 320, a coarse position 210 of automated vehicle 100 is determined.

In step 330, first environment data values are determined as a function of the coarse position 210, the first environment data values representing a target environment 220 of automated vehicle 100.

In step 340, second environment data values are recorded by an environment sensor system 101 of automated vehicle 100, the second environment data values representing an actual environment 230 of automated vehicle 100.

In step 350, a highly accurate position 240 of automated vehicle 100 is determined as a function of a comparison between the actual environment 230 and the target environment 220.

In step 360, automated vehicle 100 is operated as a function of the highly accurate position 240.

Method 300 ends with step 370.

1-9. (canceled)

10. A method for operating an automated vehicle, comprising the following steps:
determining a coarse position of the automated vehicle;
determining first environment data values as a function of the coarse position, the first environment data values representing a target environment of the automated vehicle;
recording second environment data values using an environment sensor system of the automated vehicle, the second environment data values representing an actual environment of the automated vehicle;
determining a highly accurate position of the automated vehicle as a function of a comparison between the actual environment and the target environment; and
operating the automated vehicle as a function of the highly accurate position.

11. The method as recited in claim 10, wherein the determination of the first environment data values occurs by reading the first environment data values from a map.

12. The method as recited in claim 10, wherein the determination of the first environment data values occurs as a function of the environment sensor system of the automated vehicle.

13. The method as recited in claim 12, wherein the determination of the first environment data values occurs as a function of the environment sensor system of the automated vehicle in such a way that the target environment corresponds to the expected actual environment of the automated vehicle.

14. The method as recited in claim 10, wherein the determination of the highly accurate position occurs in that the target environment includes at least one environmental feature, at least one first parameter being assigned to the at least one environmental feature, the actual environment includes at least one comparable environmental feature, at least one second parameter being assigned to the at least one comparable environmental feature, and the highly accurate position being determined as a function of the comparison between the at least one first parameter and the at least one second parameter.

15. The method as recited in claim 14, wherein the highly accurate position is determined as a function of the comparison between the at least one first parameter and the at least one second parameter in that the highly accurate position is determined by way of a function of a difference of the at least one first parameter and of the at least one second parameter.

16. The method as recited in claim 10, wherein the operation of the automated vehicle occurs in such a way that the automated vehicle s operated in automated fashion along a trajectory which is determined as a function of the highly accurate position.

17. A device for operating an automated vehicle, comprising:
a coarse position determiner configured to determine a coarse position of the automated vehicle;
an environment data determiner configured to determine first environment data values as a function of the coarse position, the first environment data values representing a target environment of the automated vehicle;
a recorder configured to record second environment data values using an environment sensor system of the automated vehicle, the second environment data values representing an actual environment of the automated vehicle;
a highly accurate position determiner configured to determine a highly accurate position of the automated vehicle as a function of a comparison between the actual environment and the target environment; and
a control unit configured to operate the automated vehicle as a function of the highly accurate position.

18. The device as recited in claim 17, wherein the determination, by the highly accurate position determiner, of the highly accurate position occurs in that the target environment includes at least one environmental feature, at least one first parameter being assigned to the at least one environmental feature, the actual environment includes at least one comparable environmental feature, at least one second parameter being assigned to the at least one comparable environmental feature, and the highly accurate position being determined as a function of the comparison between the at least one first parameter and the at least one second parameter.
